(19) United States
(12) Patent Application Publication
(10) Pub. No.: US 2008/0273241 A1
(43) Pub. Date: Nov. 6, 2008

(54) Apparatus to enable an automobile driver to see above oversized vehicles and other obstacles

(76) Inventor: Evan Robert Kaiser, Seekonk, MA (US)

Correspondence Address: EVAN KAISER, 3 ANNA COURT, SEEKONK, MA, 02771, US

(21) Appl. No.: 11/799,948

(22) Filed: May 3, 2007

(51) Int. Cl. G02B 23/08

(52) U.S. Cl. 359/402; 359/409

(57) ABSTRACT

An apparatus to enable an automobile driver to see above oversized vehicles and other obstacles with a periscope that attaches to the roof and windshield (or side window) of a motor vehicle, a sleeve mechanism that permits extension and rotation of the device, placement at the top of the windshield (or side window) that permits easy viewing, a powerful magnet and roof latch that secures the scope to the vehicle, and an optional zoom function that permits enlargement of a sighted object.: A preferred embodiment includes sturdy, weather-proof construction, availability in many colors, pre-assembly, and easy attachment.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of optics and more specifically to an apparatus to enable an automobile driver to see above oversized vehicles and other obstacles.

The driver of a motor vehicle has always been in need of designs and devices to assist and extend visibility. Full enclosure of the cab critically amplifies this need. Side and rear view mirrors provide constricted views in directions otherwise invisible to the driver. Wide angle mirror designs expand these views, though crucial areas around the vehicle remain invisible even under the best circumstances. As for the windshield, side and rear windows themselves, maximal glass surface area optimizes routine views around the vehicle.

Recently remote camera set-ups have been developed to permit seeing to the immediate rear of vehicles as a safety precaution: the risk of striking an object or person while backing up is a well recognized hazard. This development highlights an evolution in travel that has exacerbated visibility problems for drivers: the oversized vehicle. It is more difficult for drivers of these vehicles to see in and around their own vehicles—hence the need for rear-view cameras. It is also more difficult for drivers of other vehicles to see over and around these SUVs and trucks—hence the role for my invention.

While prior technology increased a driver's visibility to the side, behind, and close by a vehicle, he frequently remained blind beyond the car or truck immediately in front of him. This perennial problem has been greatly exacerbated by the proliferation of oversized vehicles, which thereby create a hazard. What is needed is a means to see over the SUV or truck directly obstructing the forward view.

### BRIEF SUMMARY OF THE INVENTION

The primary object of the invention is to enable the driver to see past obstructing over-sized vehicles.

A particular object of the invention is to enable the driver to see ahead to upcoming intersections and curves, important road details (e.g. construction hazards), and the location (e.g. left or right side of street) of unfamiliar destinations in time to react to them.

Another object of the invention is to enable the driver to see otherwise invisible oncoming and crosswise traffic when waiting to cross an intersection or turn onto a crossing road.

Yet another object of the invention is to enable the driver to see ahead when stopped in traffic.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus to enable an automobile driver to see above oversized vehicles and other obstacles comprising: a periscope that attaches to the roof and windshield or side window of a motor vehicle, a sleeve mechanism that permits extension and rotation of the device, placement at the top of the windshield or side window that permits easy viewing, a powerful magnet and roof latch that secures the scope to the vehicle, and an optional zoom function that permits enlargement of a sighted object.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the invention.

FIG. 2 is a birds-eye view of the invention.

FIG. 3 is an alternate embodiment of the invention.

FIG. 4 is a birds-eye view of an alternate embodiment of the invention.

FIG. 5 is a frontal view of an alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

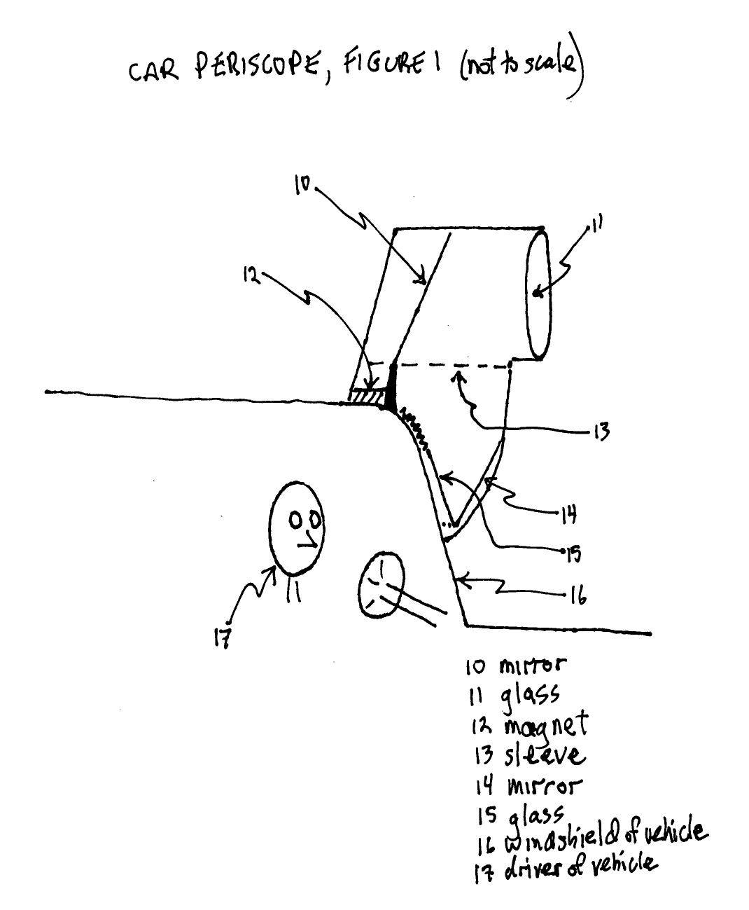

Turning to FIG. 1, one sees a cross section of a periscope that attaches to the roof and windshield of a motor vehicle. The device would be comprised of sturdy, all-weather materials and would be available in many colors in order to match commercially available automobiles. The mode of attachment in this embodiment is a powerful magnet (12) and roof latch that secures placement of the scope on the vehicle; alternatively, a kit to permit assembly and attachment of the device to the vehicle roof permanently with bolts could be included, or the periscope could be integrated in the vehicle's construction at the factory. The lens of the device sits high above the top of the vehicle, providing the driver with a high vantage point from which he can see past oversized vehicles and other obstacles. The mechanism permits light to enter the scope through the glass lens (11), reflect off of mirrors (10 & 14), penetrate the windshield or other window (15), and then be seen by the driver (17). The sleeve (13) permits rotation and extension of the telescope—full rotation could be permitted for rear viewing. A zoom apparatus might be optionally attached to the lens (11) to permit enlargement of sighted objects and therefore closer investigation of items of interest—this apparatus could be motorized, and permit shifting from normal view to wide-angle viewing.

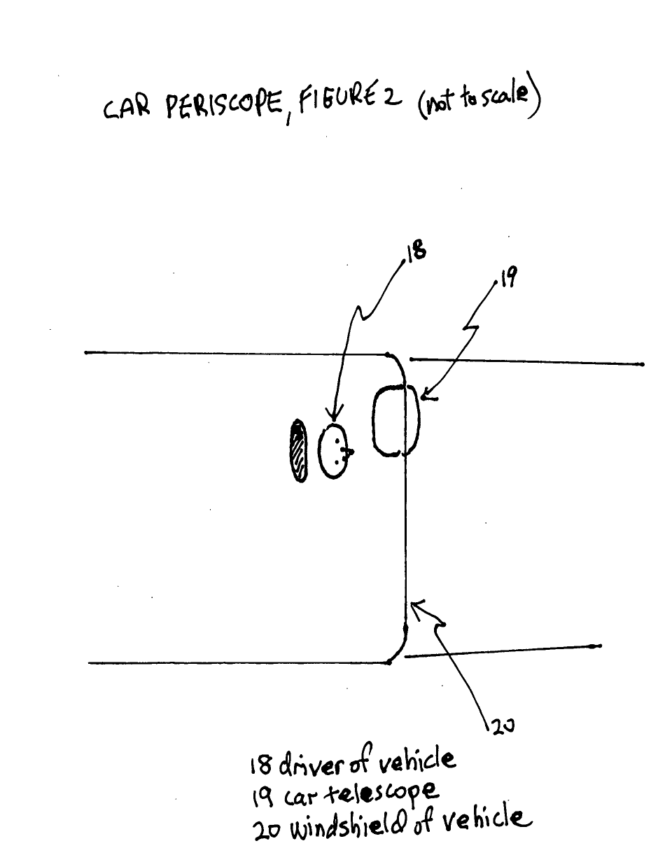

Turning to FIG. 2, one sees a different perspective of the main embodiment of the invention.

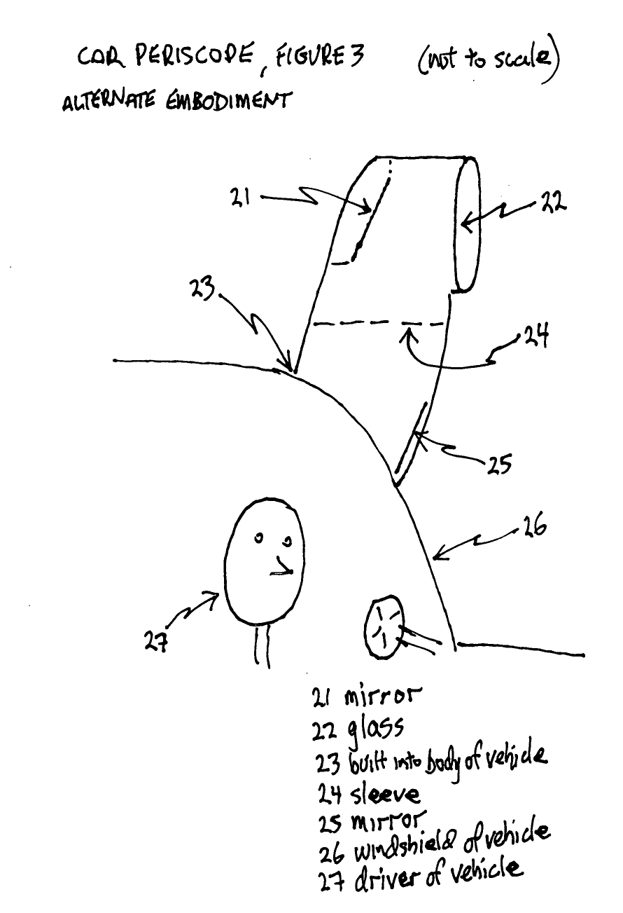

Turning to FIG. 3, one sees a variation of the device comprising integration into the body of the vehicle.

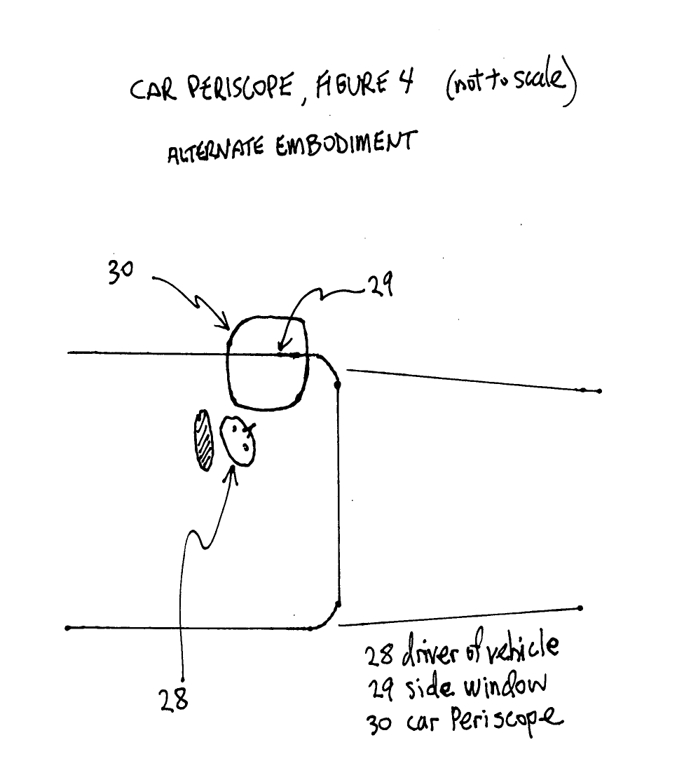

Turning to FIG. 4, one sees a birds-eye perspective of an alternative embodiment of the invention, comprising a side mount, situated at the driver side window.

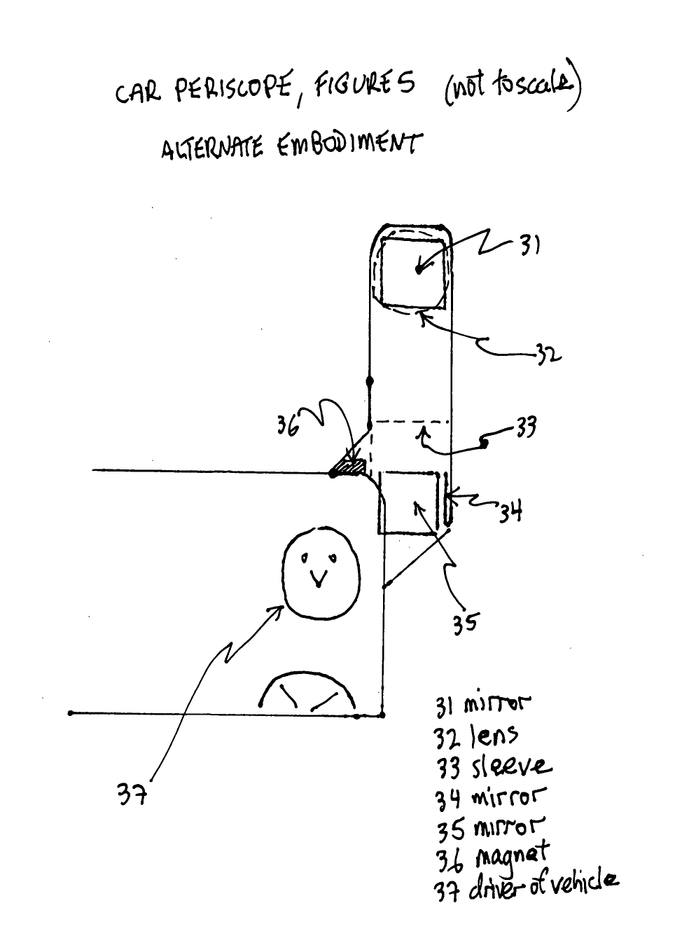

Turning now to FIG. 5, one sees the side mount variation of the device in a frontal view. The mechanism permits light to enter the scope through the glass lens (31), reflect off three mirrors (32, 34, & 35), penetrate the side window, and then be seen by the driver (37).

Used as described above, the device will enable a driver to expand his range of vision and thereby surmount the challenge of oversized vehicles and other obstacles on today's roadways.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus to enable an automobile driver to see above oversized vehicles and other obstacles comprising:
a periscope that attaches to the roof and windshield (or side window) of a motor vehicle;
a sleeve mechanism that permits extension and rotation of the device;
placement at the top of the windshield (or side window) that permits easy viewing;
a powerful magnet and roof latch that secures the scope to the vehicle; and
an optional zoom function that permits enlargement of a sighted object.

2. An apparatus to enable an automobile driver to see above oversized vehicles and other obstacles as claimed in claim 1 further comprising:
sturdy, weather-proof construction;
availability in many colors;
pre-assembly; and
easy attachment.

3. An apparatus to enable an automobile driver to see above oversized vehicles and other obstacles as claimed in claim 1 further comprising the options of:
integration in the vehicle's construction at the factory;
full rotation for rear viewing;
placement at the side window, or near the middle of the windshield near the rear-view mirror;
a kit to permit attachment of the device to the vehicle roof permanently with bolts; and
a motorized lens system that permits shifting from normal view to wide-angle view.
